(19) United States
(12) Patent Application Publication
(10) Pub. No.: US 2007/0166468 A1
(43) Pub. Date: Jul. 19, 2007

(54) Method to make vessel with heat insulation surface layer

(75) Inventors: Sheng-Shu Chang, Taichung (TW); Hung-Ying Su, Taoyuan City (TW)

Correspondence Address: TROXELL LAW OFFICE PLLC, SUITE 1404, 5205 LEESBURG PIKE, FALLS CHURCH, VA, 22041, US

(73) Assignee: Rich Cup Bio-Chemical Technology Co., Ltd.

(21) Appl. No.: 11/331,041

(22) Filed: Jan. 13, 2006

(51) Int. Cl. B05D 3/02

(52) U.S. Cl. 427/373

(57) ABSTRACT

One method to make vessel with heat insulation surface layer, which is to mix liquid adherence agent with heated foam particle powder, then coat above said compound paint on the planned size by continuous paper or surface of molded vessels, and then heat this paper or vessel so that this surface is foamed due to foam particle, meanwhile, this liquid adherence agent adheres to surface of this vessel, foaming layer can be formed on this surface, again cut this coating cloth and make vessel or apply to surface of this vessel, such as paper or surface of plastic vessel, which can provide head insulation effect, holder can't feel hot and scald when it is filled full of high temperature articles, it can also provide heat preservation effect; furthermore, pattern model can also be applied to surface, spray or roll above said compound paint after added pigment, the above said paint sprayed on flower pattern may foam by heating so as to form protruding colorful cubic flower pattern or printed in color after formed cubic flower pattern, which can present multiple and beautiful vision, meanwhile, this protruding cubic flower pattern can provide heat insulation function to holder, it also features in beauty, heat preservation, heat insulation and scald-proof.

### BACKGROUND OF THE INVENTION

1) Field of the Invention

This invention relates to a method to make vessel with heat insulation surface layer and its product, especially indicates compound paint mixing liquid adherence agent with heating foam particle powder, and coat colorful paint on external layer of target article, this surface layer may form one foaming layer and combined into one entity by heating, furthermore, cubic flower pattern is thereby formed on this surface layer with image model as coating cloth, so that it can provide multiple beauty, heat preservation, heat insulation and scald prevention effect.

2) Description of the Prior Art

Most of common vessels are made from paper or plastic material in order to control cost and popularize usage, such as paper or plastic material-made cup, bowl, disc or vessel made from this material, for example: packing vessel, heat-preserving vessel, snack box, etc.

### SUMMARY OF THE INVENTION

1. Problem to Solve:

1. The paper-made vessel is single layer which can't provide heat preservation and insulation effect, if enfold in double layers or separate a spacing, it may result in high product cost if throw away after once use, therefore, it isn't economic.

2. This plastic vessel is single layer so that it can't preserve and insulate heat.

3. In order to beautify the surface layer of paper or plastic material-made vessel, the only method is to print flower pattern on its surface layer, which can't provide cubic flower pattern effect.

4. In order to get scald-proof effect, the current paper cup usually requires another plastic support cup to hold it, however, it is inconvenient to apply this kind of paper cup with plastic support sup, furthermore, this plastic support cup must be kept after this paper cup is thrown away, so, it may further weaken the convenience of paper cup.

II. Solutions:

1. This invention applies liquid adherence agent to mix with heated foam particle powder, then coat above said compound coating cloth in paper-defining zone or surface of all molded vessels, heat this paper or vessel so that one foaming layer is formed on this surface layer, then cut this coating cloth and make vessel accordingly, or apply to surface layer of this vessel, such as surface layer of paper or plastic vessel, which can provide heat insulation effect, so, when fill full of high temperature material, holder may not feel hot and scalding, therefore, it can provide heat preservation, heat insulation and scald-proof effect.

2. This invention is to spray the above said compound paint with pigment or roll with roller so that the former coated paint with flower pattern may be formed by heating, which may become protruding colorful and cubic flower pattern, or print in color after formed cubic flower pattern so as to present multiple beautiful vision effect, therefore, this protruding cubic flower pattern can provide holder heat insulation function, it features in beauty, heat preservation, heat insulation and scald-proof.

3. This invention is applicable to surface of all paper and plastic-made vessel, all types of cubic flower pattern can be made on basis of pattern model, it is not only beautiful, but also provide scald-proof to holder by this protruding flower pattern.

4. The protruding degree of above said cubic flower pattern is based on thickness of compound paint coated, heating temperature shall be controlled from 80 to 160° C. so as to obtain required protruding flower pattern.

### BRIEF DESCRIPTION OF THE DRAWINGS

FIG. 1 is the diamonds sketch map of manufacturing flow of this invention.

FIG. 2 is the plane sketch map of idler wheel of this invention.

FIG. 2-A is the plane sketch map of this invention's coated semi-product of paper-made vessel.

FIG. 2-B is this invention's actualized example drawings before and after coating.

FIG. 2-C is the pattern-actualizing example of coated surface layer of this invention.

FIG. 3-A is the surface-foaming examples of paper or plastic-made vessel of this invention.

FIG. 3-B is the flower pattern foaming example of paper or plastic-made vessel's surface layer of this invention.

FIG. 3-C is another surface-foaming examples of paper or plastic-made vessel of this invention.

FIG. 4-A is the state to form full foaming layer when this invention is applied to paper and plastic-made vessel.

FIG. 4-B is the state to form partial foaming layer when this invention is applied to paper and plastic-made vessel.

FIG. 4-C is the state to form filling foaming layer when this invention is applied to hollow surface of paper and plastic-made vessel.

### DETAILED DESCRIPTION OF THE PREFERRED EMBODIMENTS

The actualized examples are hereby specially to describe in the following so that the commissioner can further understand technical contents of this invention.

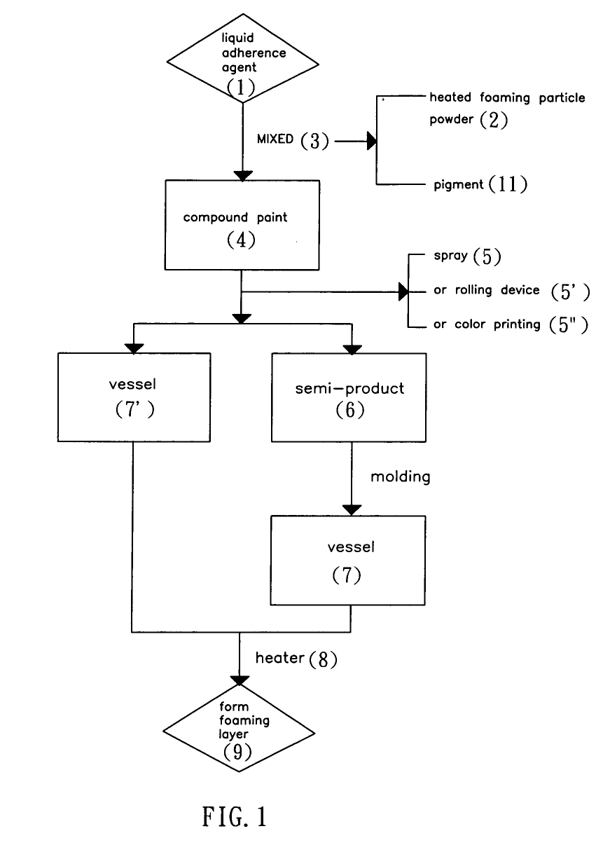

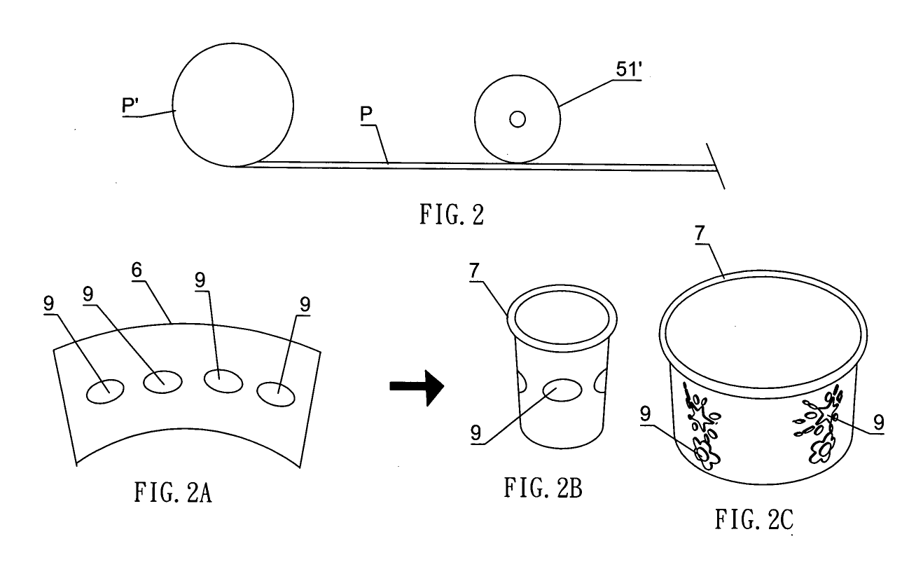

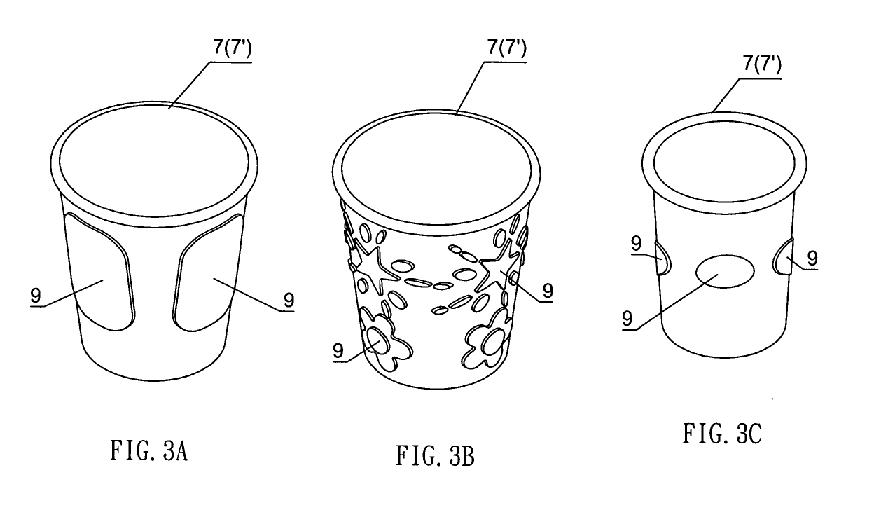

Please refer to FIG. 1, manufacturing method of this invention is as follows: liquid adherence agent 1 adds foam particle powder 2 by heating, which produces compound paint 4 after mixed 3, then coat above said compound paint 4 on surface of semi-product 6 (such as FIG. 2) or vessel 7,7′ (such as FIG. B-C and FIG. 3A-C) with coating method, at least include steps such as spray 5, roller 5′ and color printing 5″, then heat vessel 7,7′ with heater 8 so that its surface is foamed based on heating foam particle powder 2, meanwhile, this liquid adherence agent 1 adheres to surface of vessel 7,7′ so that foaming layer 9 is formed on this surface, which can reinforce it and provide heat insulation and heat preservation effect.

Above said liquid adherence agent 1 can be water base or oily, meanwhile, it is adhesive in course of foaming.

Please refer to FIG. 1 and FIG. 2, the above said compound paint 4 can directly set one pattern model on roller 51′ of rolling device 5′, then pattern model on roller 51′ of rolling device 5′ can copy compound paint 4 on continuous output paper P of roll paper p′, then cut it into planned size of vessel 7 that can make semi-product 6 (such as FIG. 2-A), after molded by vessel (it is not described hereby since it is not feature of this invention ), then heat vessel 7(7′) so as to form foaming layer 9 on its surface.

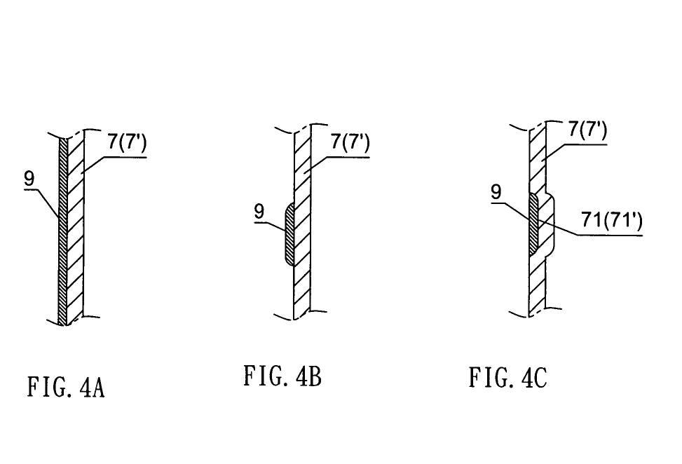

Please refer to FIG. 1, FIG. 2 and FIG. 4, it is applied to surface of paper-made vessel 7 or pre-ejecting molded plastic vessel 7′ based on above said method, which can insulate heat so that cup-holder can't feel scald as cup is filled full of high temperature articles, it can even more provide heat preservation effect; in addition, please refer to FIG. 3-A-C, flower pattern model can also be applied to surface layer, spray above said paint on flower pattern or apply rolling device (first and second drawing) to roll compound paint 4 on flower pattern, then heat it with heating device, cubic flower pattern 9 is therefore formed due to foaming, meanwhile, such protruding flower pattern can provide holder heat insulation effect, furthermore, it features in beauty, heat preservation, heat insulation and scald-proof.

Please refer to FIG. 1, FIG. 2-A˜C, FIG. 3-A˜C, FIG. 4-A˜C, such as above said vessel 7(7′), compound paint 4 can be coated on any position and size of vessel where to hold it, no need to coat all vessel; also can depress 71(71′) vessel while molding (shown as FIG. 4-C) according to suitable scope, and then coat compound paint in depressed position 71(71′) so that it may fill up depressed position 71(71′) when foamed by heating, surface layer of vessel 71(71′) resumes level, where can provide scald-proof effect and reduce production cost accordingly.

Please refer to FIG. 1, FIG. 3-A˜C, FIG. 4-A,C, pigment 11 can be filled into above said compound paint 4 so that the foamed position produces colorful flower pattern; and foaming position of foaming layer (FIG. 4-B,C) or overall foaming layer 9 may also show colorful pattern by use of color printing 5″ after compound paint 4 is foamed and combined with surface of vessel 7(7′).

Above said protruding degree of cubic flower pattern indicates the protruding thickness obtained by heating 80 to 160° C.

Above said executive examples of this invention are only used for reference, which includes all types of paper or plastic-made vessel, such as cup, bowl, tray, snack box and packing containers, so as to provide heat insulation, heat preservation, scald-proof and strengthening effect.

What is claimed is:

1. One method to make vessel with heat insulation surface layer, its steps include:
a. Mix liquid adherence agent with heated foam particle powder so as to make compound paint;
b. Coat this compound paint on surface of paper or plastic-made vessel or semi-product;
c. Then heat this vessel coated this compound paint with heating device;
d. This compound paint is foamed on surface of this vessel so as to form foaming layer;
e. This foaming layer is to coagulate due to liquid adherence agent of this compound paint and combine with surface of this vessel into one entity.
Therefore, the foaming layer of this vessel surface can be strengthened and provide heat insulation, heat preservation and scald-proof effect.

2. As claimed in claim 1, it is one method to make vessel with heat insulation surface layer, wherein pattern model can be applicable to surface of this vessel, spray or roll above said compound paint so that this compound paint with flower pattern can be foamed by heating, protruding cubic flower pattern may be formed, this protruding flower pattern can provide heat insulation to holder, it features in beauty, heat preservation, heat insulation and scald-proof.

3. As claimed in claim 1, it is one method to make vessel with heat insulation surface layer, wherein liquid adherence agent in compound paint can be water base or oily, which can be coagulated in course of foaming by heating.

4. As claimed in claim 1, it is one method to make vessel with heat insulation surface layer, wherein this compound paint can be directly coated on continuous paper, then cut it into the planned size of this vessel, heat this vessel so that foaming layer can be formed on surface of vessel after molded.

5. As claimed in claim 1, it is one method to make vessel with heat insulation surface layer, wherein one hollow and size can be directly set on holding position of this vessel, then coat compound paint on this hollow position, compound paint may fill up this hollow position after foamed by heating, so that surface of vessel may resume level, therefore, the holding position can prevent scald, the production cost may also be reduced accordingly.

6. As claimed in claim 1, it is one method to make vessel with heat insulation surface layer, wherein the protruding degree of cubic flower pattern is the protruding thickness obtained by heating 80 to 160° C.

7. As claimed in claim 1, it is one method to make vessel with heat insulation surface layer, wherein the above said method can make foaming layer of paper or plastic-made vessel, such as cup, bowl, tray, snack box and packing containers.

8. As claimed in claim 1, it is one method to make vessel with heat insulation surface layer, wherein this compound paint can add pigment so that the foamed position can produce colorful flower pattern.

9. As claimed in claim 1, it is one method to make vessel with heat insulation surface layer, wherein after this compound paint is foamed, then apply color printing to this foamed flower pattern or foaming position so as to show colorful flower pattern.
